(19) United States
(12) Patent Application Publication
(10) Pub. No.: US 2024/0340641 A1
(43) Pub. Date: Oct. 10, 2024

(54) METHOD AND APPARATUS FOR MANAGING KEYS IN DUAL CONNECTIVITY IN MOBILE COMMUNICATION SYSTEM

(71) Applicant: Samsung Electronics Co., Ltd., Gyeonggi-do (KR)

(72) Inventors: Hongjin CHOI, Gyeonggi-do (KR); Taehyung LIM, Gyeonggi-do (KR); Seungri JIN, Gyeonggi-do (KR); June HWANG, Gyeonggi-do (KR)

(21) Appl. No.: 18/627,557

(22) Filed: Apr. 5, 2024

(30) Foreign Application Priority Data
Apr. 5, 2023 (KR) 10-2023-0044955
Dec. 20, 2023 (KR) 10-2023-0187387

(51) Int. Cl. H04W 12/041; H04W 12/106; H04W 76/20

(52) U.S. Cl. CPC H04W 12/041; H04W 12/106; H04W 76/20

(57) ABSTRACT

The disclosure relates to a 5G or 6G communication system supporting a higher data transmission rate. A method and an apparatus for managing keys by a UE in dual connectivity in a wireless communication system. A method performed by a MN in a wireless communication system includes generating a first key for a first SN based on a first SN counter and a second key for a second SN based on a second SN counter; transmitting, to the first SN, a first request message including the first key for the first SN; transmitting, to the second SN, a second request message including the second key for the second SN; and transmitting, to a UE, an RRC connection reconfiguration message including the first SN counter and the second SN counter.

### CROSS-REFERENCE TO RELATED APPLICATION(S)

This application is based on and claims priority under 35 U.S.C. § 119 to Korean Patent Application Nos. 10-2023-0044955 and 10-2023-0187387, which were filed in the Korean Intellectual Property Office on Apr. 5, 2023, and Dec. 20, 2023, respectively, the entire disclosure of each of which is incorporated herein by reference.

### BACKGROUND

### 1. Field

The disclosure relates generally to a wireless communication system (or a mobile communication system), and more particularly, to a method and an apparatus for managing keys by a user equipment (UE) in dual connectivity in a wireless communication system.

### 2. Description of Related Art

5^{th} generation (5G) mobile communication technologies define broad frequency bands such that high transmission rates and new services are possible, and can be implemented in “sub 6 GHz” bands such as 3.5 GHz, as well as in “above 6 GHz” bands, which may be referred to as mmWave, including 28 GHz and 39 GHz. In addition, it has been considered to implement 6^{th} generation (6G) mobile communication technologies (i.e., beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

Since the initial development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input, multiple-output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of a bandwidth part (BWP), new channel coding methods, such as a low density parity check (LDPC) code for transmission of a large amount of data and a polar code for highly reliable transmission of control information, layer 2 (L2) pre-processing, and network slicing for providing a dedicated network specialized to a specific service.

There are ongoing discussions regarding improvement and performance enhancement of initial 5G mobile communication technologies in view of services to be supported by future 5G mobile communication technologies, such as physical layer standardization regarding technologies including vehicle-to-everything (V2X) for aiding driving determination by autonomous vehicles based on information regarding positions and states of vehicles transmitted by the vehicles and for enhancing user convenience, new radio unlicensed (NR-U), which is aimed at system operations conforming to various regulation-related requirements in unlicensed bands, new radio (NR) user equipment (UE) power saving, a non-terrestrial network (NTN), which includes UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There is also ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, the number of connected devices that will be connected to communication networks is expected to exponentially increase, and it is accordingly expected that enhanced functions and performances of 5G mobile communication systems and integrated operations of connected devices will be necessary. To this end, new research is scheduled in connection with extended Reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

A UE may perform dual connectivity. In dual connectivity, a base station (BS) providing micro cell coverage may operate as a maser node (MN) and may process both a control plane and a user plane (UP), and another BS having small cell coverage may operate as a secondary node (SN) and may serve as an assistant for processing the UP. That is, the MN may process control signaling, and the SN may be used to improve a data transmission rate. The MN may provide conditional primary secondary cell (PSCell) change (CPC) configuration information to the UE, and the UE may evaluate the condition and, when the condition is satisfied, make a request for a change to the SN satisfying the condition. Further, the UE may store the CPC configuration information for several SNs provided by the MN and continuously make SN change requests whenever the condition is satisfied after the evaluation.

### SUMMARY

An aspect of the disclosure is to address a security problem by newly generating a key whenever an SN is changed, in order to prevent a previously generated key from being used when a UE continuously changes the SN, based on CPC configuration information received from an MN in dual connectivity.

In accordance with an aspect of the disclosure, a method is provided for an MN in a wireless communication system. The includes generating a first key for a first SN based on a first SN counter and a second key for a second SN based on a second SN counter; transmitting, to the first SN, a first request message including the first key for the first SN; transmitting, to the second SN, a second request message including the second key for the second SN; and transmitting, to a UE, an RRC connection reconfiguration message including the first SN counter and the second SN counter.

In accordance with another aspect of the disclosure, a method is provided for a UE in a wireless communication system. The method includes receiving, from an MN, an RRC connection reconfiguration message including a first SN counter for a first SN and a second SN counter for a second SN; and generating a first key for the first SN based on the first SN counter.

In accordance with another aspect of the disclosure, an MN is provided for use in a wireless communication system. The MN includes a transceiver; and a controller coupled with the transceiver and configured to generate a first key for a first SN based on a first SN counter and a second key for a second SN based on a second SN counter, transmit, to the first SN, a first request message including the first key for the first SN, transmit, to the second SN, a second request message including the second key for the second SN, and transmit, to a UE, an RRC connection reconfiguration message including the first SN counter and the second SN counter.

In accordance with another aspect of the disclosure, a UE is provided for use in a wireless communication system. The UE includes a transceiver; and a controller coupled with the transceiver and configured to receive, from an MN, an RRC connection reconfiguration message including a first SN counter for a first SN and a second SN counter for a second SN, and generate a first key for the first SN based on the first SN counter.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a communication network including core network (CN) entities in a wireless communication system according to an embodiment;

FIG. 1B illustrates a wireless environment including a CN in a wireless communication system according to an embodiment;

FIG. 2A illustrates a UE according to an embodiment;

FIG. 2B illustrates a BS according to an embodiment;

FIG. 2C illustrates a CN entity according to an embodiment;

FIG. 3 is a signal flow diagram illustrating a process in which a UE and an MN generate K_{SN} in a dual connectivity condition according to an embodiment;

FIG. 4 is a signal flow diagram illustrating a process in which a UE and an MN generate K_{SN} when a conditional continuous SN change is made in a dual connectivity condition according to an embodiment; and

FIG. 5 is a signal flow diagram illustrating a process in which a UE and an MN generate K_{SN} when a conditional continuous SN change is made in a dual connectivity condition according to an embodiment.

### DETAILED DESCRIPTION

Hereinafter, various embodiments of the disclosure will be described in detail with reference to the accompanying drawings. In the following description of the disclosure, a detailed description of known functions or configurations incorporated herein will be omitted when it is determined that the description may make the subject matter of the disclosure unnecessarily unclear.

The terms which will be described below are terms defined in consideration of the functions in the disclosure, and may be different according to users, intentions of the users, or customs. Therefore, the definitions of the terms should be made based on the contents throughout the specification.

The terms used in the disclosure are only used to describe specific embodiments, and are not intended to limit the disclosure.

A singular expression may include a plural expression unless they are definitely different in a context. Unless defined otherwise, all terms used herein, including technical and scientific terms, have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

In the accompanying drawings, some elements may be exaggerated, omitted, or schematically illustrated. Further, the size of each element does not completely reflect the actual size. In the drawings, identical or corresponding elements may be provided with identical or corresponding reference numerals.

Advantages and features of the disclosure and ways to achieve them will be apparent by making reference to embodiments as described below in detail in conjunction with the accompanying drawings. However, the disclosure is not limited to the embodiments set forth below, but may be implemented in various different forms. Instead, the following embodiments are provided only to completely disclose the disclosure and inform those skilled in the art of the scope of the disclosure, and the disclosure is defined only by the scope of the appended claims.

Although various embodiments of the disclosure will be described based on an approach of hardware, the disclosure includes a technology that uses both hardware and software, and thus the various embodiments of the disclosure may not exclude the perspective of software.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

Herein, the term “unit” may refer to a software element or a hardware element, such as a field programmable gate array (FPGA) or an application specific integrated circuit (ASIC), which performs a predetermined function. However, a “unit” does not always have a meaning limited to software or hardware. A “unit” may be constructed either to be stored in an addressable storage medium or to execute one or more processors. Therefore, a “unit” includes, e.g., software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card.

In order to promote evolution from a conventional 4^{th} generation (4G) long term evolution (LTE) system to a 5G system, the 3^{rd} generation partnership project (3GPP), which is in charge of cellular mobile communication standards, has named a new CN structure as a 5G core (5GC) and standardized it. The 5GC supports differentiated functions compared to an evolved packet core (EPC) that is a network core for the conventional 4G.

More specifically, a network slice function is introduced in the 5GC. As requirements of 5G, the 5GC should support various types of UEs and services (e.g., eMBB, URLLC, or mMTC service). These various types of services have different requirements required for the CN. For example, an eMBB service requires a high data rate, and a URLLC service requires high stability and low latency. One of the technologies proposed to satisfy the various service requirements is network slicing.

The network slicing is a method of virtualizing a physical network to generate several logical networks, and network slice instances (NSIs) may have different characteristics. Accordingly, every NSI may have a network function (NF) suitable for the characteristic and thus meet various service requirements. Various 5G services may be efficiently supported by allocating an NSI suitable for the service characteristic required for each UE.

5GC may support a network virtualization paradigm through separation of a mobility management function and a session management function (SMF). In conventional 4G LTE, all UEs may receive services through a signaling exchange with single core equipment, i.e., a mobility management entity (MME) in charge of registration, authentication, mobility management, and SMFs for all UEs. However, when the single equipment such as the MME supports all functions, as the number of UEs increases and mobility and traffic/session characteristics, which should be supported according to the UE type, are subdivided in 5G, scalability for adding entities according to each of the required functions cannot help being reduced. Accordingly, various functions are developed based on a structure of dividing a mobility management function and an SMF in order to improve a function/implementation complexity of a core equipment serving a control plane and expandability in the light of signaling load.

In the following description, a BS is an entity that allocates resources to terminals, and may be at least one of an eNode B (eNB), a Node B, a radio access network (RAN), an access network (AN), a RAN node, an NR NB, a gNode B (gNB), a wireless access unit, a BS controller, or a node on a network.

A terminal may include a user UE, a mobile station (MS), a cellular phone, a smartphone, a computer, or a multimedia system capable of performing communication functions. Embodiments of the disclosure will be described herein with reference to the terminal being a UE by way of example.

Furthermore, in the following description, a system based on LTE, LTE-A, or NR will be described by way of example, but various embodiments of the disclosure may be applied to other communication systems having similar technical backgrounds or channel types. Moreover, based on determinations by those skilled in the art, various embodiments of the disclosure may be applied to other communication systems through some modifications without significantly departing from the scope of the disclosure.

In the following description, terms for identifying access nodes, terms referring to network entities, terms referring to messages, terms referring to interfaces between network entities, terms referring to various identification information, etc., are illustratively used for the sake of descriptive convenience. Therefore, the disclosure is not limited by the terms as used below, and other terms referring to subjects having equivalent technical meanings may be used.

In the disclosure, various embodiments will be described using terms employed in some communication standards, (e.g., the 3GPP standards), but these terms are merely for the sake of descriptive convenience. Various embodiments of the disclosure may also be easily applied to other communication systems through modifications.

According to an embodiment of the disclosure, a method performed by a UE may include receiving, from an MN, an indication of whether the MN supports a selective SCG, transmitting, to the MN, an indication of whether the UE supports the selective SCG, storing and managing an SN counter received from the MN, informing the MN of an SN counter value used by the UE for a key, generating the key using the SN counter value, and storing a value obtained by adding 1 to the SN counter value as a new SN counter.

According to an embodiment of the disclosure, a method performed by a BS, which operates as an MN, in a wireless communication system may include transmitting, to a UE, an indication of whether the MN supports a selective SCG, receiving, from the UE, an indication of whether the selective SCG is supported, determining whether K_{SN} is generated before the MN transmits an SN addition request message to an SN, determining whether to transmit an SN counter when the MN transmits an RRC connection reconfiguration message to the UE, determining a number of SN counters to be transmitted when the MN transmits the RRC connection reconfiguration message to the UE, receiving, from the UE, SN counters used for generating K_{SN}, generating the key using the SN counter value, and storing a value obtained by adding 1 to the value as a new SN counter

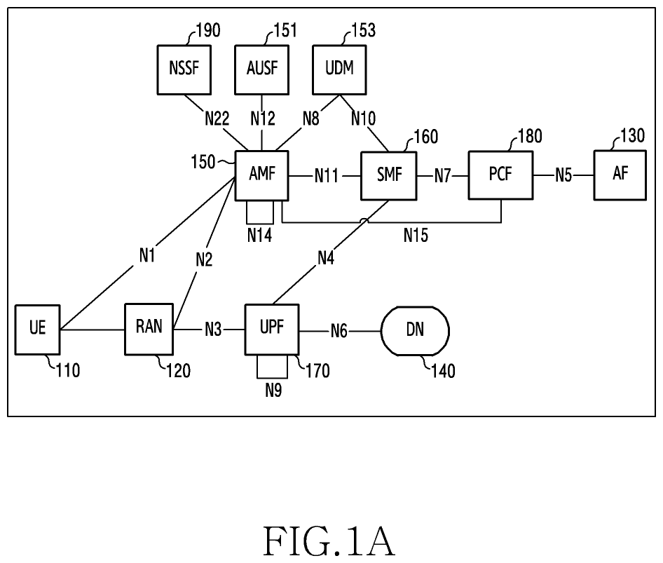

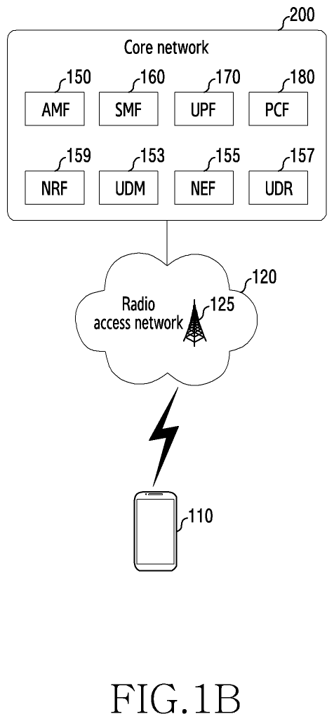

FIG. 1A illustrates a communication network including CN entities in a wireless communication system according to an embodiment.

Referring to FIG. 1A, a 5G mobile communication network includes a 5G UE 110, a 5G RAN 120, and a 5G CN.

The 5G CN may include NFs, such as an AMF 150 for providing a mobility management function of the UE, an SMF 160 for providing an SMF, a user plane function (UPF) 170 serving to transmit data, a policy control function (PCF) 180 for providing a PCF, a unified data management (UDM) 153 for providing a function of managing data, such as subscriber data and policy control data, or a unified data repository (UDR) for storing data of various NFs.

The UE 110 may perform communication through a radio channel, i.e., an AN configured with a BS (e.g., an eNB or a gNB). In some embodiments, the UE 110 is a device used by the user and may be configured to provide a user interface (UI). The UE 110 may be a terminal mounted to a vehicle for driving, or may be a device performing MTC operated without intervention of the user or an autonomous vehicle. The UE may also be referred to as a terminal, a vehicle terminal, a mobile station, a subscriber station, a remote terminal, a wireless terminal, a user device, or by other terms having an equivalent technical meaning, as well as an electronic device. As a terminal, customer-premise equipment (CPE) or a dongle type terminal as well as the UE may be used. The CPE may be connected to an NG-RAN node like the UE, but may provide a network to other communication equipment (e.g., a laptop).

The AMF 150 may provide a function for access and mobility management in units of UEs 110, and one UE 110 may be basically connected to one AMF 150.

Specifically, the AMF 150 may perform at least one function of performing signaling between CN nodes for mobility between 3GPP ANs, providing an interface (e.g., an N2 interface) between wireless ANs (e.g., a 5G RAN) 120, performing non-access stratum (NAS) signaling with the UE 110, identifying the SMF 160, and transmitting a session management (SM) message between the UE 110 and the SMF 160. Some or all of the functions of the AMF 150 may be supported within a single instance of one AMF 150.

The SMF 160 provides the SMF, and when the UE 110 has a plurality of sessions, respective sessions may be managed by different SMFs 160. Specifically, the SMF 160 may perform at least one function of managing a session (e.g., establishing, modifying, and releasing a session including maintenance of a tunnel between the UPF 170 and an AN node), selecting and controlling a UPF, configuring traffic steering for routing traffic from the UPF 170 to an appropriate destination, ending an SM part of an NAS message, notifying of downlink data (i.e., a downlink data notification (DDN), and transferring to an AN through an N2 interface via an initiator (e.g., the AMF 150) of AN-specific SM information. Some or all of the functions of the SMF 160 may be supported within a single instance of one SMF 160.

In a 3GPP system, conceptual links that connect NFs within the 5G system may be referred to reference points. A reference point may also be referred to as an interface. Reference points (or interfaces) included in 5G system architecture include:
N1: a reference point between the UE 110 and the AMF 150
N2: a reference point between the (R)AN 120 and the AMF 150
N2: a reference point between the (R)AN 120 and the UPF 170
N4: a reference point between the SMF 160 and the UPF 170
N5: a reference point between the PCF 180 and the AF 130
N6: a reference point between the UPF 170 and the DN 140
N7: a reference point between the SMF 160 and the PCF 180
N8: a reference point between the UDM 153 and the AMF 150
N9: a reference point between two core UPFs 170
N10: a reference point between the UDM 153 and the SMF 160
N11: a reference point between the AMF 150 and the SMF 160
NG12: a reference point between the AMF 150 and the authentication server function (AUSF) 151
N13: a reference point between the UDM 153 and the AUSF 151
N14: a reference point between two AMFs 150
N15: a reference point between the PCF 180 and the AMF 150 in non-roaming scenario and a reference point between the PCF 180 and the AMF 150 within visited network in roaming scenario

FIG. 1B illustrates a wireless environment including a CN in a wireless communication system according to an embodiment.

Referring to FIG. 1B, the wireless communication system includes a RAN 120 and a CN 200.

The RAN 120 is a network directly connected to a user device, e.g., the UE 110, and corresponds to infrastructure providing radio access to the UE 110. The RAN 120 includes a set of a plurality of BSs including a BS 125, and the plurality of BSs may perform communication through an interface configured therebetween. At least some of the interfaces between the plurality of BSs may be wired or wireless. The BS 125 may have a structure in which a central unit (CU) and a distributed unit (DU) are separated. In this case, one CU may control a plurality of DUs. The BS 125 may be referred to as access point (AP), a gNB, a 5G node, a wireless point, a transmission/reception point (TRP), or another term having a meaning equivalent thereto.

The UE 110 may access the RAN 120 and communicate with the BS 125 through a wireless channel. The UE 110 may be referred to a mobile station, a subscriber station, a remote terminal, a wireless terminal, a user device, or by other terms having the equivalent technical meaning.

The CN 200 manages the total system, and may control the RAN 120 and process data and control signals for the UE 110 transmitted and received through the RAN 120. The CN 200 may perform various functions such as the control of a AN and a control plane, processing of mobility, management of subscriber information, charging, and interworking with other types of systems (e.g., an LTE system).

In order to perform various functions, the CN 200 may include a plurality of functionally separated entities having different NFs. For example, the CN 200 includes the AMF 150, the SMF 160, the UPF 170, the PCF 180, the network repository function (NRF) 159, the UDM 153, the network exposure function (NEF) 155, and the UDR 157. However, the NFs included in the CN 200 are not limited to the above-described NFs and may further include different NFs.

The UE 110 may be connected to the RAN 120 and may access the AMF 150 performing the mobility management function of the CN 200. The AMF 150 is a function or a device serving to perform both the access of the RAN 120 and the mobility management of the UE 110. The SMF 160 is an NF managing a session. The AMF 150 may be connected to the SMF 160, and the AMF 150 may route a message related to a session for the UE 110 to the SMF 160. The SMF 160 may be connected to the UPF 170 and may allocate AN resources to be provided to the UE 110 and establish a tunnel for transmitting data between the BS 125 and the UPF 170. The PCF 180 may control information related to a policy for a session used by the UE 110 and charging.

The NRF 159 may perform a function of storing information on NFs installed in a mobile communication operator network and informing of the stored information. The NRF 159 may be connected to all NFs. When each NF operates in the operator network, the NF is registered in the NRF 159, so the NRF 159 is informed that the NF operates within the network. The UDM 153 is an NF playing a similar role to a home subscriber server (HSS) of the 4G network and may store subscription information of the UE 110 or context used by the UE 110 within the network.

The NEF 155 may serve to connect a 3^{rd} party server with the NF within the 5G mobile communication system. Further, the NEF 155 may serve to provide data to the UDR 157, or update or acquire the data. The UDR 157 may perform a function of storing subscription information of the UE 120, storing data exposed to the outside, or storing information required for a 3^{rd} party application. Further, the UDR 157 may serve to provide the stored data to another NF.

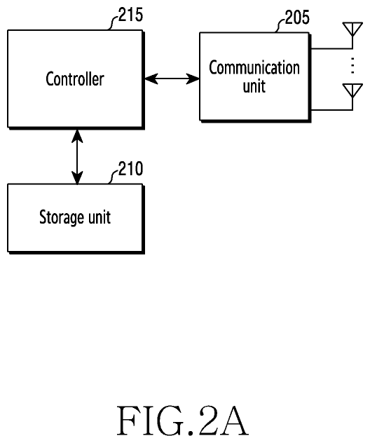

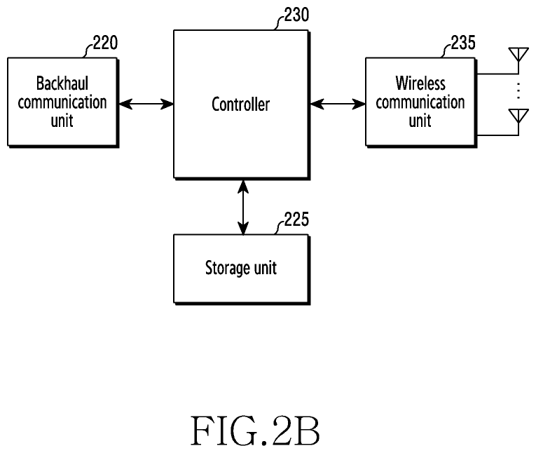

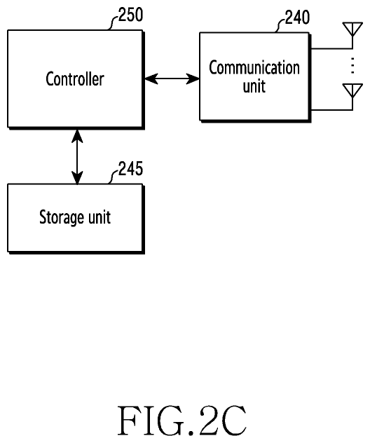

FIG. 2A illustrates a UE according to an embodiment. For example, the UE 110 of FIG. 1A may be configured as illustrated in FIG. 2A.

Herein, the term ‘˜unit’ or ‘˜er’ refers to a unit for processing at least one function or operation, which may be implemented in hardware, software, or a combination of hardware and software.

Referring to FIG. 2A, the UE includes a communication unit 205, a storage unit 210, and a controller 215.

The communication unit 205 may perform functions for transmitting and receiving signals through radio channels. For example, the communication unit 205 may perform a function of conversion between a baseband signal and a bitstream according to the physical layer standard of the system. In data transmission, the communication unit 205 may generate complex symbols by encoding and modulating a transmission bitstream. In data reception, the communication unit 205 may reconstruct the reception bitstream by demodulating and decoding the baseband signal. The communication unit 205 may up-convert the baseband signal into a radio frequency (RF) band signal, transmit the RF band signal through an antenna, and then down-convert the RF band signal received through the antenna to the baseband signal. For example, the communication unit 205 may include a transmission filter, a reception filter, an amplifier, a mixer, an oscillator, a digital-to-analog convertor (DAC), and an analog-to-digital convertor (ADC).

The communication unit 205 may include a plurality of transmission/reception paths. The communication unit 205 may include at least one antenna array including a plurality of antenna elements. On the hardware side, the communication unit 205 may include a digital circuit and an analog circuit (e.g., an RF integrated circuit (RFIC)). The digital circuit and the analog circuit may be implemented as one package. The communication unit 205 may include a plurality of RF chains. The communication unit 205 may perform beamforming.

The communication unit 205 may transmit and receive the signals as described above. Accordingly, all or some of the communication unit 205 may be referred to as a “transmitter”, a “receiver”, or a “transceiver”. In the following description, transmission and reception performed through a radio channel include the processing performed by the communication unit 205.

The storage unit 210 may store data such as a basic program for the operation of the UE, an application, and configuration information. The storage unit 210 may include volatile memory, nonvolatile memory, or a combination of volatile memory and nonvolatile memory. The storage unit 210 may provide the stored data according to a request of the controller 215.

The controller 215 may control the overall operation of the UE. For example, the controller 215 may transmit and receive signals through the communication unit 205. The controller 215 records data in the storage unit 210 and reads the same. The controller 215 may perform the functions of a protocol stack required by the communication standard. To this end, the controller 215 may include at least one processor or microprocessor, or may be a part of the processor. Further, the part of the communication unit 205 or the controller 215 may be referred to as a communications processor (CP). The controller 215 may control performance of synchronization using a wireless communication network. For example, the controller 215 may control the UE to perform operations according to various embodiments described below.

The UE may include a mobile equipment (ME) and a universal mobile telecommunications service (UTMS) subscriber identity module (USIM). The ME may include a mobile terminal (MT) and a terminal equipment (TE). The MT may be a part in which a radio access protocol operates, and the TE may be a part in which a control function operates. For example, the MT and the TE may be integrated in the case of a wireless communication terminal (e.g., a mobile phone), and the MT and the TE may be separated in the case of a notebook. The ME and the USIM may be expressed as separated entities according to the operation of each configuration, but it is not limited thereto, and all of the ME and the USIM may be expressed as the terminal (e.g., the UE) or the ME may be expressed as the terminal in various embodiments of the disclosure.

FIG. 2B illustrates a BS according to an embodiment. For example, the BS 125 in FIG. 1B may be configured as illustrated in FIG. 2B.

Referring to FIG. 2B, the BS includes a wireless communication unit 235, a backhaul communication unit 220, a storage unit 225, and a controller 230.

The wireless communication unit 235 may perform functions for transmitting and receiving signals through wireless channels. For example, the wireless communication unit 235 may perform a function of conversion between a baseband signal and a bitstream according to the physical layer standard of the system. In data transmission, the wireless communication unit 235 may generate complex symbols by encoding and modulating a transmission bitstream. In data reception, the wireless communication unit 235 may reconstruct the reception bitstream by demodulating and decoding the baseband signal.

The wireless communication unit 235 may up-convert the baseband signal into an RF band signal, transmit the same through an antenna, and then down-convert the RF band signal received through the antenna into the baseband signal. To this end, the wireless communication unit 235 may include a transmission filter, a reception filter, an amplifier, a mixer, an oscillator, a DAC, and an ADC. Further, the wireless communication unit 235 may include a plurality of transmission/reception paths. In addition, the wireless communication unit 235 may include at least one antenna array including a plurality of antenna elements.

On the hardware side, the wireless communication unit 235 may include a digital unit and an analog unit, and the analog unit may include a plurality of sub-units according to operating power and operating frequency. The digital unit may be implemented as at least one processor (e.g., digital signal processor (DSP)).

The wireless communication unit 235 may transmit and receive the signals as described above. Accordingly, all or part of the wireless communication unit 235 may be referred to as a “transmitter”, a “receiver”, or a “transceiver”. Further, transmission and reception performed through a radio channel may include the above-described processing by the wireless communication unit 235.

The backhaul communication unit 220 may provide an interface for communicating with other nodes within the network. That is, the backhaul communication unit 220 may convert a bitstream, which the BS transmits to another node, e.g., another access node, another BS, a higher node, a CN, etc., into a physical signal and convert a physical signal received from another node to a bitstream.

The storage unit 225 may store data such as a basic program, an application, configuration information, and the like for the operation of the BS. The storage unit 225 may include volatile memory, nonvolatile memory, or a combination of volatile memory and nonvolatile memory. The storage unit 230 may provide the stored data according to a request of the controller 240.

The controller 230 may control the overall operation of the BS. For example, the controller 230 may transmit and receive signals through the wireless communication unit 235 or through the backhaul communication unit 220. The controller 230 records data in the storage unit 225 and reads the data. The controller 230 may perform the functions of a protocol stack required according to communication standards.

According to another implementation, the protocol stack may be included in the wireless communication unit 235. To this end, the controller 230 may include at least one processor. The controller 230 may control performance of synchronization using a wireless communication network. For example, the controller 230 may control the BS to perform operations according to various embodiments described below.

FIG. 2C illustrates a CN entity according to an embodiment. For example, the AMF 150 of FIG. 1A may be configured as illustrated in FIG. 2C.

Referring to FIG. 2C, the CN entity includes the communication unit 240, the storage unit 245, and the controller 250.

The communication unit 240 may provide an interface for communicating with other devices within the network. That is, the communication unit 240 may convert a bitstream transmitted from the CN entity to another device into a physical signal and convert a physical signal received from another device into a bitstream. That is, the communication unit 240 may transmit and receive signals. Accordingly, the communication unit 240 may be referred to as a modem, a transmitter, a receiver, or a transceiver. The communication unit 240 may allow the CN entity to communicate with other devices or systems via the backhaul connection (e.g., a wired backhaul or a wireless backhaul) or via the network.

The storage unit 245 may store data, such as a basic program, an application program, and configuration information for the operation of the CN entity. The storage unit 245 may include volatile memory, nonvolatile memory, or a combination of volatile memory and nonvolatile memory. The storage unit 245 may provide the stored data according to a request of the controller 250.

The controller 250 may control the overall operations of the CN entity. For example, the controller 250 may transmit and receive signals through the communication unit 240. The controller 250 records data in the storage unit 245 and reads the data. To this end, the controller 250 may include at least one processor. The controller 250 may control performance of synchronization using a wireless communication network. For example, the controller 250 may control the CN entity to perform operations according to various embodiments described below.

Terms for identifying access nodes used in the following description, terms referring to network entities, terms referring to messages, terms referring to interfaces between network entities, and terms referring to various pieces of identification information are used for convenience of description. Accordingly, the disclosure is not limited to the following terms and other terms having the same technical meaning may be used.

For convenience of description, the disclosure may use the terms and names defined in a 5G system (5GS) and NR standard, as defined by the 3GPP. However, the disclosure is not limited by the terms and names and may be equally applied to a wireless communication network complying with another standard.

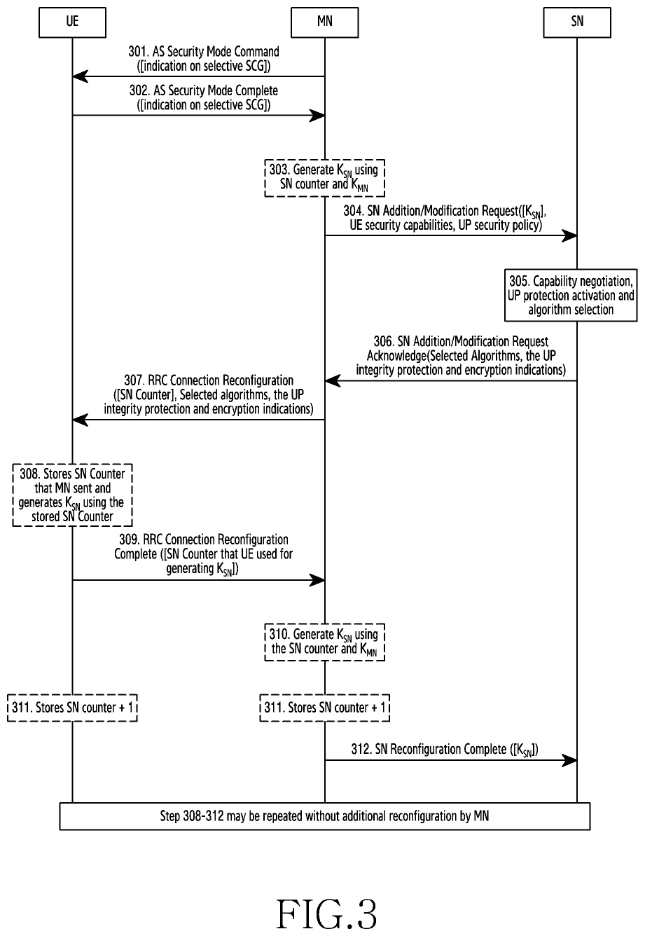

FIG. 3 is a signal flow diagram illustrating a process in which a UE and an MN generate K_{SN} in a dual connectivity condition according to an embodiment.

Referring to FIG. 3, the UE and the MN may generate K_{SN}, which is a key used by an SN. More specifically, an SN may generate another key used for encryption and integrity protection of UP data exchanged between the UE and the SN using K_{SN}.

In step 301, the MN transmits, to the UE, through an AS Security Mode Command message, an indication of whether a selective SCG is supported by the MN. When the MN does not transmit the indication, it may imply that the MN does not support the selective SCG. The AS Security Mode Command message may be a first integrity-protected message among access stratum (AS) messages. The AS may be a functional layer of the protocol stack between the radio network and the UE. The selective SCG may be a process in which, when the MN makes a request for allocating resources for a protocol data unit (PDU) session or a quality of service (QoS) flow for the UE to several SNs and the MN transmits an RRC reconfiguration message including SN RRC configuration conditional information for each SN, the UE continuously performs a process of, when a specific condition is satisfied using the received conditional information, making a change to an SN satisfying the condition. That is, when the MN transmits the indication that the selective SCG is supported, the UE receiving the SN RRC configuration conditional information for several SNs may transmit an SN change request to the MN whenever the condition is satisfied, without additional configuration information received from the MN.

In step 302, the UE transmits, to the MN, through an AS Security Mode Complete message, an indication of whether a selective SCG is supported by the UE. When the UE does not transmit the indication, it may imply that the UE does not support the selective SCG. The AS Security Mode Complete message may be a first encrypted and integrity-protected message among the AS messages.

In step 303, the MN may generate K_{SN} by using an SN counter and K_{MN} according to circumstances. The SN counter may be a counter value of 16 bits maintained by the MN or the UE and may be used to generate K_{SN}. K_{SN} is a key used by the SN, and the SN may generate another key used for encryption and integrity protection of UP data exchanged between the UE and the SN using K_{SN}. In order to generate K_{SN}, the MN may use K_{MN}, 0x79, an SN counter value, and an SN counter length as input values. The cases in which the MN determines to not generate K_{SN} in step 303 may include, e.g., when the MN knows that the UE supports the selective SCG or the MN knows that a request for allocating resources should be made to several SNs to allow the UE to make the conditional SN change.

In step 304, the MN makes a request, to the SN, through an SN Addition/Modification Request message, for allocating resources for one or more PDU sessions or a QoS flow. The MN transmits the SN Addition/Modification Request message together with at least one of K_{SN}, UP security capabilities (e.g., a list of encryption algorithms and a list of integrity protection algorithms supported by the UE), or a UP security policy (e.g., a value among “Required”, “Preferred”, and “Not Needed” for encryption and integrity protection as an indication indicating whether to perform UP data encryption and integrity protection). If the MN does not generate K_{SN} in step 303, the MN may not transmit K_{SN} in step 304.

Although not illustrated in FIG. 3, the request for allocating resources to the SN by the MN through the SN Addition/Modification Request message may not be limited to the request for allocating resources to one SN. For example, the MN may make a request for allocating resources to several SNs.

In step 305, the SN selects whether to perform UP data encryption or integrity protection, based on the UP security capabilities and UP security policy received in step 304 and, if the SN decides to perform UP data encryption or integrity protection, selects an algorithm.

In step 306, when the SN allows the request for allocating resources from the MN in step 304, the SN transmits an SN Addition/Modification Request Acknowledge message in response to the SN Addition/Modification Request message. The SN Addition/Modification Request Acknowledge message may additionally include at least one of an algorithm selected by the SN, an indication indicating whether UP data integrity protection is performed, or an indication indicating whether UP data encryption is performed. Further, the SN Addition/Modification Request Acknowledge message may include an SN RRC configuration message including a radio resource configuration.

In step 307, the MN transmits, to the UE, an RRC Connection Reconfiguration message, which may include the SN RRC configuration message(s) received from the SN(s) in step 306. Further, the RRC Connection Reconfiguration message may include at least one of an SN counter managed by the MN, an algorithm selected by the SN, or an indication indicating whether UP data encryption and integrity protection is performed.

After the MN transmits the SN counter value in step 307, the UE may store the received SN counter value transmitted by the MN in step 308. If the SN counter value transmitted by the MN is smaller than the SN counter value stored in the UE, the UE may transmit an error message to the MN. The UE may generate K_{SN} with K_{MN}, 0x79, the SN counter, and the SN counter length as inputs.

If the MN does not transmit the SN counter value in step 307, the UE may generate K_{SN} by using the SN counter value stored in the UE.

In step 309, the UE transmits, to the MN, through an RRC Connection Reconfiguration Complete message, a response message indicating the application of one of the configuration information provided by the MN. At this time, the MN may be informed of the SN counter value used by the UE for generating K_{SN} in step 308.

If the MN does not generate K_{SN} in step 303, then in in step 310, the MN may generate K_{SN} with the SN counter value, K_{MN}, 0x79, and the SN counter length transmitted by the UE in step 309 as inputs. If the SN counter value transmitted by the UE is smaller than the SN counter value stored in the MN, the MN may transmit an error message to the UE.

If the MN generates K_{SN} in step 310, the MN may add 1 to the SN counter value used in step 310 and store the value in step 311. If the UE transmits the SN counter value used by the UE for generating K_{SN} through the RRC Connection Reconfiguration Complete message in step 309, the UE may add 1 to the SN counter value and store the value after transmitting the RRC Connection Reconfiguration message.

If the MN generates K_{SN} in step 310, not in step 303, the MN may add K_{SN} to the SN Reconfiguration Complete message and transmit the SN Reconfiguration Complete message to the SN in step 312.

Step 308 to 312 may be continuously generated without any additional performance of step 301 to 307.

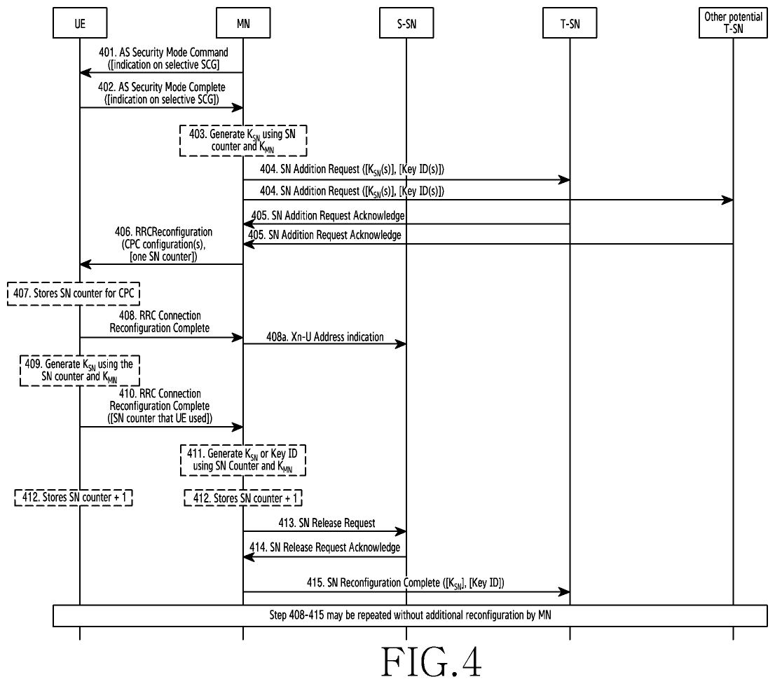

FIG. 4 is a signal flow diagram illustrating a process in which a UE and an MN generate K_{SN} when a conditional continuous SN change is made in a dual connectivity condition according to an embodiment.

Referring to FIG. 4, in step 401, the MN transmits, to the UE, through an AS Security Mode Command message, an indication of whether a selective SCG is supported by the MN. When the MN does not transmit the indication, it may imply that the MN does not support the selective SCG. The AS Security Mode Command message may be a first integrity-protected message among the AS messages. The selective SCG may be a process in which, when the MN makes a request for allocating resources for a PDU session or QoS flow for the UE to several SNs and the MN transmits an RRC reconfiguration message including SN RRC configuration conditional information for each SN, the UE continuously performs a process of, when a specific condition is satisfied using the received conditional information, making a change to an SN satisfying the condition. That is, when the MN transmits the indication indicating that the selective SCG is supported, the UE receiving the SN RRC configuration conditional information for several SNs may transmit an SN change request to the MN whenever the condition is satisfied without additional configuration information received from the MN.

In step 402, the UE transmits, to the MN, in an AS Security Mode Complete message, an indication of whether a selective SCG is supported by the UE. When the UE does not transmit the indication, it may imply that the UE does not support the selective SCG. The AS Security Mode Complete message may be a first encoded and integrity-protected message among the AS messages.

In step 403, the MN may generate K_{SN} by using an SN counter and KM according to circumstances. K_{SN} is a key used by an SN, and the SN may generate another key used for encryption and integrity protection of UP data exchanged between the UE and the SN using K_{SN}. In order to generate K_{SN}, the MN may use KM, 0x79, an SN counter value, and an SN counter length as input values. For example, the cases in which the MN determines to not generate K_{SN} in step 403 may include, e.g., when the MN knows that the UE supports the selective SCG or the MN knows that a request for allocating resources should be made to several SNs to allow the UE to make the selective SN change. The MN may generate key(s) corresponding to respective SNs through SN counter value(s) differently applied for respective SNs. That is, the MN may generate key(s) corresponding to a plurality of SNs, respectively. Further, the MN may also generate IDs for the generated keys through the used SN counter or a different value.

In step 404, the MN makes a request, to a target SN (T-SN), through an SN Addition Request message, for allocating resources for one or more PDU sessions or a QoS flow. The MN transmits the SN Addition Request message together with at least one of K_{SN}(s), ID(s) of the key(s), UP security capabilities (e.g., a list of encryption algorithms and a list of integrity protection algorithms supported by the UE), or a UP security policy (e.g., a value among “Required”, “Preferred”, and “Not Needed” for encryption and integrity protection as an indication indicating whether to perform UP data encryption and integrity protection). If the MN does not generate K_{SN} in step 403, the MN may not transmit K_{SN} in step 404. A process in which the MN makes the request for allocating resources to the SN through the SN Addition Request message in order to allow the UE to make the conditional continuous SN change my not be limited to the request for allocating resources to one SN. For example, the MN may make a request for allocating resources to several SNs.

In step 405, when the T-SN allows the request for allocating resources from the MN in step 404, the T-SN may transmit an SN Addition Request Acknowledge message in response the SN Addition Request message. The SN Addition Request Acknowledge message may additionally include at least one of an algorithm selected by the T-SN, an indication indicating whether UP data integrity protection is performed, and an indication indicating whether UP data encryption is performed. Further, the SN Addition Request Acknowledge message may include an SN RRC configuration message including a radio resource configuration.

In step 406, the MN transmits an RRC Connection Reconfiguration message, which may include the SN RRC configuration message(s) received from the T-SN(s) in step 405. The RRC Connection Reconfiguration message may include CPC configuration information. Further, the RRC Connection Reconfiguration message may include at least one of an SN counter managed by the MN, an algorithm selected by the SN, or an indication indicating whether UP data encryption and integrity protection is performed.

In step 406, the MN may transmit no SN counter value, may transmit SN counters applied for respective SNs (i.e., every SN RRC configuration includes the SN counter), or may transmit only one SN counter. The case in which the MN transmits no SN counter value or transmits only one SN counter value may include, e.g., when the MN knows that the UE supports the selective SCG through step 402. The case in which the MN transmits the SN counters applied for respective SNs may include, e.g., when the MN knows that the UE does not support the selective SCG or when the MN does not support the selective SCG.

If the MN transmits CPC configuration information and SN counter value(s) in step 406, the UE may store the received SN counter value(s) in step 407. If the SN counter value transmitted by the MN is smaller than the SN counter value stored in the UE, the UE may transmit an error message.

In step 408, the UE applies the RRCReconfiguration message transmitted by the MN, and stores the CPC configuration information transmitted by the MN in step 406. In step 408a, the MN informs a source SN (S-SN) that CPC information is configured in the UE through an Xn-U Address Indication process.

In step 409, the UE may start performance condition evaluation work, based on the CPC configuration information received from the MN in step 406. If the performance condition for one candidate SN is satisfied, the UE may prepare for the connection to the SN satisfying the performance condition. If the UE stores the SN counter value received from the MN in step 407, the UE may generate K_{SN} with the SN counter value, K_{MN}, 0x79, and the SN counter length received from the MN as inputs. If the MN does not transmit SN counter value(s) in step 406, and thus the UE does not store the SN counter, the UE may generate K_{SN} by using the SN counter value, which the UE separately stores.

In step 410, the UE transmits an RRC Connection Reconfiguration Complete message, informing the MN of the selected SN, after the performance condition evaluation based on the CPC configuration information received from the MN in step 406. The message may include the SN counter value used by the UE for generating K_{SN}.

If the MN does not generate K_{SN} in step 403, then in step 411, the MN may generate K_{SN} with the SN counter value, K_{MN}, 0x79, and the SN counter length transmitted by the UE in step 410 as inputs. Further, the MN may generate key IDs by using the received SN counter value. If the SN counter value transmitted by the UE is smaller than the SN counter value stored in the MN, the MN may transmit an error message to the UE. Alternatively, although the UE does not transmit the SN counter value in step 410, the MN may generate K_{SN} by using the SN counter value stored in the MN.

If the MN generates K_{SN} in step 411, the MN may add 1 to the SN counter value used in step 411 and store the value in step 412. If the UE transmits the SN counter value used by the UE for generating K_{SN} through the RRC Connection Reconfiguration Complete message in step 410, the UE may add 1 to the SN counter value and store the value, after transmitting the RRC Connection Reconfiguration message.

In step 413, the MN may transmit an SN Release Request message to the S-SN.

In step 414, the S-SN transmits an SN Release Request Acknowledge message to the MN.

If the MN generates K_{SN} in step 411, not in step 403, the MN may add K_{SN} to the SN Reconfiguration Complete message and transmit the SN Reconfiguration Complete message to the T-SN in step 415. Further, the MN may add the key IDs received in step 411 to the SN Reconfiguration Complete message and transmit the SN Reconfiguration Complete message to the T-SN. The T-SN receiving the message may find keys corresponding thereto and use the same.

Steps 408 to 415 may be continuously generated without any additional performance of step 401 to operation 407.

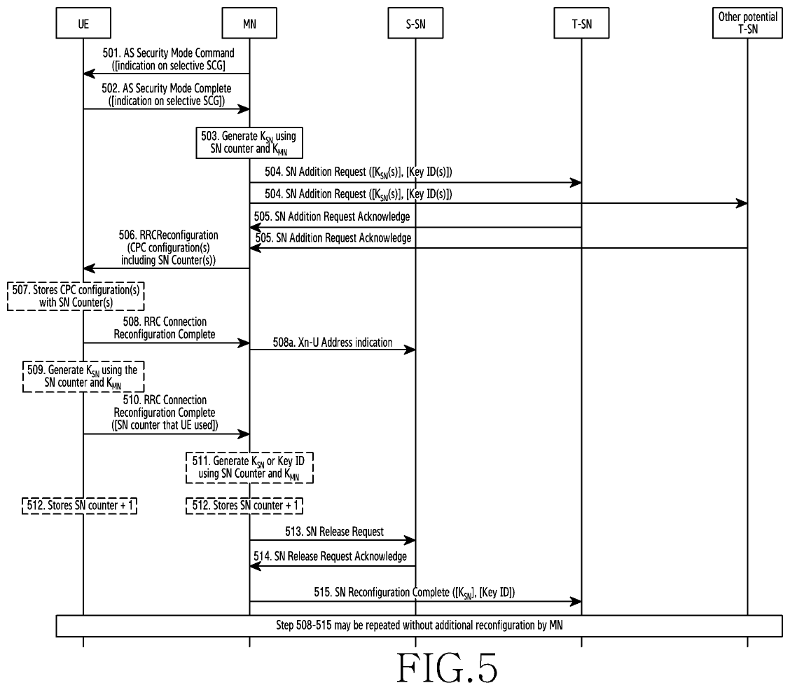

FIG. 5 is a signal flow diagram illustrating a process in which a UE and an MN generate K_{SN} when a conditional continuous SN change is made in a dual connectivity condition according to an embodiment.

Referring to FIG. 5, in step 501, the MN transmits, to the UE, through an AS Security Mode Command message, an indication of whether a selective SCG is supported by the MN. When the MN does not transmit the indication, it may imply that the MN does not support the selective SCG. The AS Security Mode Command message may be a first integrity-protected message among the AS messages. The selective SCG may be a process in which, when the MN makes a request for allocating resources for a PDU session or a QoS flow for the UE to several SNs and the MN transmits an RRC reconfiguration message including SN RRC configuration conditional information for each SN, the UE continuously performs a process of, when a specific condition is satisfied using the received conditional information, making a change to an SN satisfying the condition. That is, when the MN transmits the indication indicating that the selective SCG is supported, the UE receiving the SN RRC configuration conditional information for several SNs may transmit an SN change request to the MN whenever the condition is satisfied without additional configuration information received from the MN.

In step 502, the UE transmits, to the MN, in an AS Security Mode Complete message, an indication of whether a selective SCG is supported included by the UE. When the UE does not transmit the indication, it may imply that the UE does not support the selective SCG. The AS Security Mode Complete message may be a first encoded and integrity-protected message among the AS messages.

In step 503, the MN generates K_{SN} by using an SN counter and Km. The K_{SN} is a key used by an SN, and the SN may generate another key used for encryption and integrity protection of UP data exchanged between the UE and the SN using K_{SN}. In order to generate K_{SN}, the MN may use Km, 0x79, an SN counter value and an SN counter length as input values. The MN may generate key(s) corresponding to respective SNs through SN counter values differently applied for respective SNs. That is, the MN may generate key(s) corresponding to a plurality of SNs, respectively. Further, the MN may also generate IDs for the generated keys through the used SN counter or a different value.

In step 504, the MN makes a request for allocating resources for one or more PDU sessions or a QoS flow to a T-SN through an SN Addition Request message. The MN transmit the SN Addition Request message together with at least one of K_{SN}(s), ID(s) of the key(s), UP security capabilities (a list of encryption algorithms and a list of integrity protection algorithms supported by the UE), or a UP security policy (that may have one value among “Required”, “Preferred”, and “Not Needed” for encryption and integrity protection as an indication indicating whether to perform UP data encryption and integrity protection).

In step 505, when the T-SN allows the request for allocating resources from the MN in step 504, the T-SN transmit SN Addition Request Acknowledge in response to the SN Addition Request message. The SN Addition Request Acknowledge message may additionally include at least one of an algorithm selected by the T-SN, an indication indicating whether UP data integrity protection is performed, or an indication indicating whether UP data encryption is performed. Further, the SN Addition Request Acknowledge message may include an SN RRC configuration message containing a radio resource configuration.

In step 506, the MN transmits an RRC Connection Reconfiguration message, which may include the SN RRC configuration message(s) received from the T-SN(s) in step 505. The RRC Configuration message for each T-SN may include an SN counter value required for generating K_{SN} to be used when the T-SN is selected. The RRC Connection Reconfiguration message may include CPC configuration information (a list of RRC Connection Reconfiguration messages transmitted by respective SNs). Further, the RRC Connection Reconfiguration message may include at least one of an SN counter managed by the MN, an algorithm selected by the SN, or an indication indicating whether UP data encryption and integrity protection is performed.

When the MN transmits CPC configuration information and SN counter value(s) in step 506, the UE may store the received SN counter value(s) in step 507.

In step 508, the UE applies the RRCReconfiguration message transmitted by the MN, and stores the CPC configuration information transmitted by the MN in step 506. In step 508a, the MN informs the S-SN that CPC information is configured in the UE through an Xn-U Address Indication process.

In step 509, the UE may start performance condition evaluation work, based on the CPC configuration information received from the MN in step 506. If the performance condition for one candidate SN is satisfied, the UE may prepare for the connection to the one candidate SN satisfying the performance condition. The UE may generate K_{SN} with, as the input, the SN counter value, K_{MN}, 0x79, and the SN counter length received from the MN through the SN counter value stored in step 507.

When the UE has been previously connected to the SN through the SN counter value received from the MN, the UE may use a value, which is different from the SN counter provided by the MN, to generate K_{SN}. For example, the value which is different from the SN counter provided by the MN may be a value larger than the largest value among the SN counter values, which the UE receives, when the MN transmits the SN counter values to several SNs. When such a process is continuously performed, and thus the UE uses a value larger than the largest value among the SN counter values provided by the MN, the UE may store the value.

In step 510, the UE transmits an RRC Connection Reconfiguration Complete message informing the MN of the selected SN, after the performance condition evaluation based on the CPC configuration information received from the MN in step 506. The message may include the SN counter value used by the UE for generating K_{SN}. If the SN counter value used by the UE for generating K_{SN} is the value which the MN provides in step 506, the UE may not inform of the SN counter value.

When the UE transmits the SN counter value to the MN in step 510, the MN may generate K_{SN} with the SN counter value, K_{MN}, 0x79, and the SN counter length transmitted by the UE as inputs in step 511. Alternatively, the MN may generate key IDs by using the received SN counter value. Although the UE does not transmit the SN counter value in step 510, the MN may generate K_{SN} by using the SN counter value stored in the MN.

If the MN generates K_{SN} in step 511, the MN may add 1 to the SN counter value used in step 511 and store the value in step 512. If the UE transmits the SN counter value used by the UE for generating K_{SN} through the RRC Connection Reconfiguration Complete message in step 510, the UE may add 1 to the SN counter value and store the value after transmitting the RRC Connection Reconfiguration message.

In step 513, the MN transmits an SN Release Request message to the S-SN.

In step 514, the S-SN transmits an SN Release Request Acknowledge message to the MN.

If the MN generates K_{SN} in step 511, the MN may add K_{SN} to the SN Reconfiguration Complete message and transmit the SN Reconfiguration Complete message to the T-SN in step 515. Further, the MN may add the key IDs received in step 511 to the SN Reconfiguration Complete message and transmit the SN Reconfiguration Complete message to the T-SN. The T-SN receiving the message may find keys corresponding thereto and use the same.

The SN may use K_{SN} which was received most recently for security communication with the UE.

Steps 508 to 515 may be continuously generated without additional performance of steps 501 to 507.

It should be noted that FIGS. 1A to 5, i.e., the diagrams illustrating methods of transmitting and receiving control/data signals, and diagrams illustrating operation procedures are not intended to limit the scope of the embodiments of the disclosure. That is, it should not be construed that all element parts, entities, or operations illustrated in FIGS. 1A to 5 are essential elements for implementing the disclosure, and it should be understood that only a few elements may implement the disclosure within the scope without departing the subject matter of the disclosure.

The above-described operations of the embodiments may be implemented by providing any unit of an apparatus with a memory device storing corresponding program codes. That is, a controller of the apparatus may perform the above-described operations by reading and executing the program codes stored in the memory device by means of a processor or CPU.

Various units or modules of a network entity, a BS device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random-access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Further, a separate storage device on the communication network may access a portable electronic device.

In the above-described detailed embodiments of the disclosure, an element included in the disclosure may be expressed in the singular or the plural. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof.

What is claimed is:

1. A method performed by a master node (MN) in a wireless communication system, the method comprising:
generating a first key for a first second node (SN) based on a first SN counter and a second key for a second SN based on a second SN counter;
transmitting, to the first SN, a first request message including the first key for the first SN;
transmitting, to the second SN, a second request message including the second key for the second SN; and
transmitting, to a user equipment (UE), a radio resource control (RRC) connection reconfiguration message including the first SN counter and the second SN counter.

2. The method of claim 1, wherein the second SN counter is different from the first SN counter, and
wherein the second key is different from the first key.

3. The method of claim 1, further comprising receiving, from the UE, an RRC connection reconfiguration complete message.

4. The method of claim 1, further comprising:
generating a first set of key identifiers (IDs) based on a first set of SN counters for the first SN and a second set of key IDs based on a second set of SN counters for the second SN; and
generating a first set of keys based on the first set of SN counters for the first SN and a second set of keys based on the second set of SN counters for the second SN,
wherein the first request message further includes the first set of key IDs and the first set of keys for the first SN,
wherein the second request message further includes the second set of key IDs and the second set of keys for the second SN, and
wherein the RRC connection reconfiguration message includes the first set of SN counters for the first SN and the second set of SN counters for the second SN.

5. The method of claim 4, further comprising receiving, from the UE, an RRC connection reconfiguration complete message including the first SN counter that is used for the UE to generate the first key for the first SN,
wherein the first SN counter is included in the first set of SN counters for the first SN.

6. The method of claim 5, further comprising transmitting, to the first SN, an SN reconfiguration complete message including the first key ID that is based on the first SN counter.

7. A method performed by a user equipment (UE) in a wireless communication system, the method comprising:
receiving, from a master node (MN), a radio resource control (RRC) connection reconfiguration message including a first secondary node (SN) counter for a first SN and a second SN counter for a second SN; and
generating a first key for the first SN based on the first SN counter.

8. The method of claim 7, wherein the second SN counter is different from the first SN counter.

9. The method of claim 8, further comprising transmitting, to the MN, an RRC connection reconfiguration complete message.

10. The method of claim 9, wherein the RRC connection reconfiguration message includes a first set of SN counters for the first SN and a second set of SN counters for the second SN,
wherein the first SN counter is included in the first set of SN counters for the first SN and the second SN counter is included in the second set of SN counters for the second SN, and
wherein the first set of SN counters are used for generating a first set of keys for the first SN and the second set of SN counters are used for generating a second set of keys for the second SN.

11. A master node (MN) in a wireless communication system, the MN comprising:
a transceiver; and
a controller coupled with the transceiver and configured to:
generate a first key for a first second node (SN) based on a first SN counter and a second key for a second SN based on a second SN counter,
transmit, to the first SN, a first request message including the first key for the first SN,
transmit, to the second SN, a second request message including the second key for the second SN, and
transmit, to a user equipment (UE), a radio resource control (RRC) connection reconfiguration message including the first SN counter and the second SN counter.

12. The MN of claim 11, wherein the second SN counter is different from the first SN counter, and
wherein the second key is different from the first key.

13. The MN of claim 11, wherein the controller further configured to receive, from the UE, an RRC connection reconfiguration complete message.

14. The MN of claim 11, wherein the controller further configured to:
generate a first set of key identifiers (IDs) based on a first set of SN counters for the first SN and a second set of key IDs based on a second set of SN counters for the second SN, and
generate a first set of keys based on the first set of SN counters for the first SN and a second set of keys based on the second set of SN counters for the second SN,
wherein the first request message further includes the first set of key IDs and the first set of keys for the first SN,
wherein the second request message further includes the second set of key IDs and the second set of key s for the second SN, and
wherein the RRC connection reconfiguration message includes the first set of SN counters for the first SN and the second set of SN counters for the second SN.

15. The MN of claim 14, wherein the controller further configured to receive, from the UE, an RRC connection reconfiguration complete message including the first SN counter that is used for the UE to generate the first key for the first SN, and
wherein the first SN counter is included in the first set of SN counters for the first SN.

16. The MN of claim 15, wherein the controller further configured to transmit, to the first SN, an SN reconfiguration complete message including the first key ID that is based on the first SN counter.

17. A user equipment (UE) in a wireless communication system, the UE comprising:
a transceiver; and
a controller coupled with the transceiver and configured to:
receive, from a master node (MN), a radio resource control (RRC) connection reconfiguration message including a first secondary node (SN) counter for a first SN and a second SN counter for a second SN, and
generate a first key for the first SN based on the first SN counter.

18. The UE of claim 17, wherein the second SN counter is different from the first SN counter.

19. The UE of claim 18, wherein the controller further configured to transmit, to the MN, an RRC connection reconfiguration complete message.

20. The UE of claim 19, wherein the RRC connection reconfiguration message includes a first set of SN counters for the first SN and a second set of SN counters for the second SN,
wherein the first SN counter is included in the first set of SN counters for the first SN and the second SN counter is included in the second set of SN counters for the second SN, and
wherein the first set of SN counters are used for generating a first set of keys for the first SN and the second set of SN counters are used for generating a second set of keys for the second SN.
